(19) United States
(12) Patent Application Publication
(10) Pub. No.: US 2012/0283911 A1
(43) Pub. Date: Nov. 8, 2012

(54) SYSTEM AND METHOD FOR ADJUSTING SMOOTHNESS FOR LANE CENTERING STEERING CONTROL

(75) Inventors: Jin-Woo LEE, Rochester Hills, MI (US); Bakhtiar Brian LITKOUHI, Washington, MI (US)

(73) Assignee: GM GLOBAL TECHNOLOGY OPERATIONS LLC, Detroit, MI (US)

(21) Appl. No.: 13/101,308

(22) Filed: May 5, 2011

(51) Int. Cl. B62D 6/00

(52) U.S. Cl. 701/41

(57) ABSTRACT

A method and system may include obtaining a time to complete a lane centering maneuver for a vehicle traveling on a roadway. A lane centering path may be calculated for the maneuver, based on a sensed current heading of the vehicle relative to a sensed center line as determined by the time to complete. A steering adjustment required for the vehicle to execute the maneuver with respect to the calculated lane centering path may be calculated and applied to the vehicle.

### FIELD OF THE INVENTION

The present invention is related to steering control. More particularly, the present invention is related to smoothness adjustment of a lane centering function of a steering control system.

### BACKGROUND

Modern vehicles may be provided with capability for autonomous operation. When being autonomously operated, the need for driver intervention is reduced. Operation without constant driver intervention may reduce driver fatigue. Autonomous operation in a modern vehicle may be augmented by utilizing information obtained by sensors that are mounted in the vehicle. Such sensors (e.g. radar or a camera) may detect the presence of other vehicles, the edges of a road or lane, and various objects present on or near the road.

For example, cruise control, in which a vehicle operator sets a vehicle speed that the vehicle maintains, has long been available. Adaptive cruise control systems have been developed more recently which may adjust the vehicle speed in accordance with sensed conditions. For example, adaptive cruise control may slow the vehicle when a sensor detects that a slower moving vehicle is ahead.

Automatic steering control mechanisms have been described for providing at least limited autonomous steering. For example, autonomous steering systems have been described for such tasks as returning a vehicle to the center of a lane, maintaining a vehicle in the center of a lane, and for changing a lane. One aspect that has been addressed with regard to automatic steering has been determining a path that is consistent with vehicle capabilities and with some pre-set comfort level for the driver and passengers. Determination of the path is typically based on a detected roadway, and on a detected current state of the vehicle.

### SUMMARY

In accordance with embodiments of the present invention, an embodiment of a method and system for adjusting smoothness of a lane centering control may include obtaining, accepting, receiving or determining a time to complete a transition to lane centering maneuver for a vehicle traveling on a roadway. A lane centering path for the maneuver may be calculated, based on a sensed current heading of the vehicle relative to a sensed center line, and as determined by the time to complete. A steering adjustment required for the vehicle to execute the maneuver with respect to the calculated lane centering path may be calculated and applied to the vehicle.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic diagram of a vehicle with a lane centering system, according to an embodiment of the present invention;

FIG. 2 illustrates schematically an example of an effect of different smoothness levels on a calculated vehicle path for automatic lane centering, in accordance with an embodiment of the present invention;

FIG. 3 illustrates graphically an example of an effect of different smoothness levels on automatic lane centering, in accordance with an embodiment of the present invention;

FIG. 4A illustrates the result of adjustment of smoothness of lane centering by determining a time period for completing the lane centering on a vehicle traveling on a roadway, in accordance with an embodiment of the present invention; and

FIG. 4B is a flowchart of a method for adjustment of smoothness of lane centering by determining a time period for completing the lane centering, in accordance with an embodiment of the present invention.

Reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. In other instances, well-known methods, procedures, components, and circuits have not been described in detail so as not to obscure the present invention.

Unless specifically stated otherwise, as apparent from the following discussions, throughout the specification discussions utilizing terms such as “processing”, “computing”, “storing”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In accordance with embodiments of the present invention, an automatic lane centering process may operate with a variable smoothness. The smoothness may determine the speed (e.g., quick or gradual) with which a steering adjustment is made in order to center a vehicle in a lane. The variable smoothness may be adjusted in accordance with, for example, a driver's preference or habits. For example, a vehicle may include a control for enabling entry (e.g., by a driver of a desired smoothness parameter or value (e.g., as a continuous parameter or as a selection from a limited number of choices). The smoothness range that is available may be dependent on the type of vehicle or on the vehicle's capabilities (e.g. luxury or family car versus sports car).

For the purpose of this description, automatic lane centering is to be understood as referring to automatically guiding a vehicle so as to attain and maintain a predetermined route or position with respect to an edge of, or a center line of, a lane or roadway. Automatic lane centering may include in some embodiments guiding a vehicle to change lanes (e.g. guiding the vehicle to the center of a lane that is adjacent to a lane in which the vehicle is currently traveling), or to travel along an off-center route that is closer to one side of a lane than to the other. Automatic lane centering should also be understood as referring to guiding a vehicle to or along a predetermined route or position defined with respect to a defined roadway, whether or not the roadway is marked as having separate lanes. Thus, the term “lane” should also be understood as referring to any defined roadway.

In accordance with embodiments of the present invention, a vehicle with an automatic lane centering system may include one or more sensors. The sensors automatically acquire information that enables a processor of the system to determine a position of vehicle with respect to a lane, as well as a motion of the vehicle with respect to the lane. In addition, information may be acquired from one or more sensors that indicate a state of operation of the vehicle (e.g. speed, acceleration, yaw rate, steering angle). The vehicle may include an input device whereby a driver may indicate a decision to activate or deactivate lane centering, and whereby the driver may indicate a preferred smoothness. For example, the input device may accept input which is translated into a smoothness level.

On the basis of the acquired information, as well as on the basis of the indicated preferred smoothness, a lane centering system may calculate a transition path that the vehicle is to take in order to achieve lane centering, e.g., to go from a non-centered path (e.g., driver operated) to a centered path (e.g., autonomous). As discussed, “centered” may include a path that is straight (or curved on a constant curvature or varying curvature road) along or which follows a lane but which is “off center” to the extent that the vehicle is closer to one side of a lane or road than another. The system may then operate the steering of the vehicle in order to follow the calculated transition path. At various time intervals or within time periods that are determined by the system, a relative position or motion of the vehicle to the calculated transition path is determined, and a steering adjustment is made accordingly.

In one embodiment, a lane centering transition maneuver may include providing driving or steering instructions (e.g., steering wheel positions) that are required to move the path of a vehicle from a non-lane-centered path, to a lane centered path. The lane centered path may be the path calculated to be a guided path along the lane. The path may be defined by the edge of a road, a set of lane markings, or a center line, which may be an abstract line determined by the system relative to the edge or lines. E.g., a center line may be the path a lane centering system sets relative to a lane or road. In some embodiments of the present invention the center line may be off center, for example, designed to keep the vehicle further from one side of the lane. A lane centering transition path may be calculated to maneuver the vehicle from the non-centered path to the lane centering path. The lane centering path may be defined by the center line. While as discussed herein, when a lane centering system is initiated, transition path is taken from the path of the vehicle when operated by a driver to a centered or guided path, the lane centering system may operate to guide the vehicle while in the transition path and when the vehicle is in the guided path.

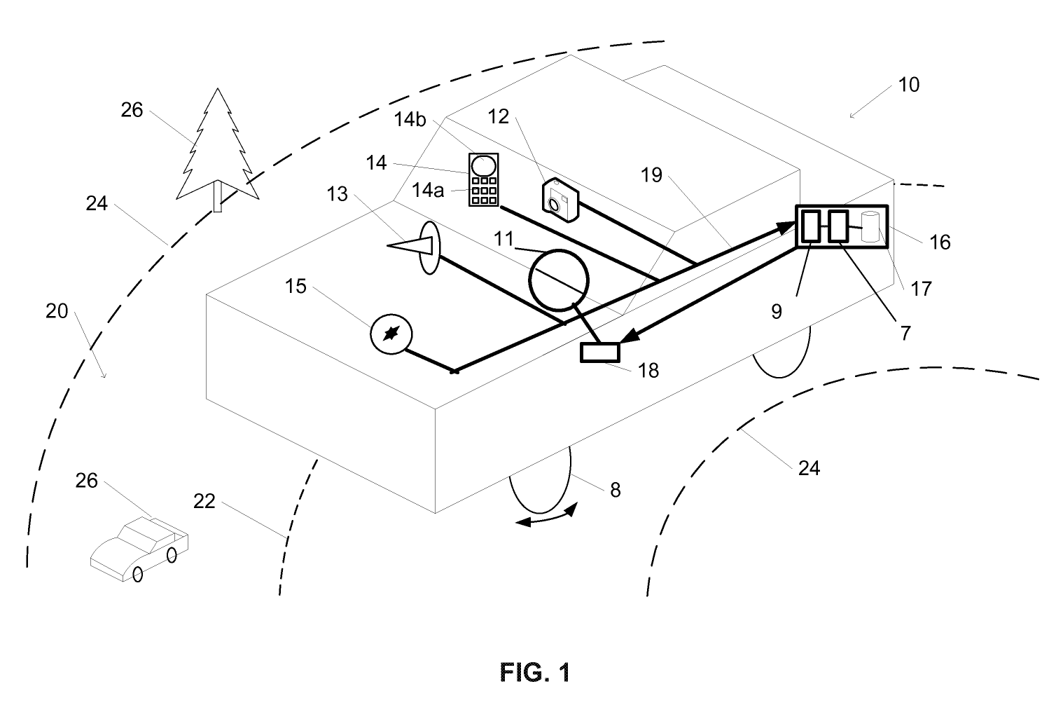

FIG. 1 is a schematic diagram of a vehicle with a lane centering system, according to an embodiment of the present invention.

Vehicle 10 includes automatic lane centering system 16 and steering wheel 11. For example, automatic lane centering system 16 may control vehicle 10 so as to cause vehicle 10 to travel along center line 22 (to be understood as representing any desired route that is defined relative to lane markings 24, the edge of a road, or another defined desired route) of lane 20 or of a road or other path.

Automatic lane centering system 16 may include a processor 9 and memory 7.

Automatic lane centering system 16 may include or communicate with non-transitory data storage device 17 for storing programmed instructions, as well as data that is acquired and generated by automatic lane centering system 16. Processor 9 may be one or more controllers or central processing units and may execute instructions or code stored in memory 9 and/or storage 17 to carry out embodiments of the present invention.

Non-transitory data storage device 17 may be or may include, for example, a random access memory (RAM), a read only memory (ROM), a dynamic RAM (DRAM), a synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Data storage device 17 may be or may include multiple memory units. Data storage device 17 may be or may include, for example, a hard disk drive, a floppy disk drive, a compact disk (CD) drive, a CD-Recordable (CD-R) drive, a universal serial bus (USB) device or other suitable removable and/or fixed storage unit, and may include multiple or a combination of such units.

Automatic lane centering system 16 may be connected to, or communicate with, one or more systems or assemblies of vehicle 10.

Automatic lane centering system 16 may be mounted on or within a dashboard or elsewhere within a passenger compartment of vehicle 10. Alternatively, automatic lane centering system 16 may be located in a trunk, engine compartment, or other compartment of vehicle 10. Alternatively, automatic lane centering system 16 may include one or more portable devices that may be plugged into, or otherwise connected to (e.g. remotely or wirelessly), vehicle 10. Automatic lane centering system 16 may be part of, or associated with, accept location information from, or include, a conventional vehicle location detection system such as a global positioning system (GPS) device.

Automatic lane centering system 16 may receive input from one or more sensors or input devices, collectively indicated by input 19.

Driver interface device 14 is typically located where it may be conveniently accessed by a driver (to be understood as including a driver, a passenger, a person remotely controlling vehicle 10, or an onboard or remote device that automatically controls vehicle 10). For example, driver interface device 14 may be mounted to a dashboard of vehicle 10, to a steering wheel 11 of vehicle 10, a steering column of vehicle 10, an instrumentation cluster panel, or a radio console. Driver interface device 14 may include a portable device that may be placed by the driver at a convenient location within a passenger compartment of vehicle 10.

Driver interface device 14 may include at least one user control 14a. User control 14a may include, for example, one or more buttons, knobs, touch panels, or levers. User control 14a may enable a driver to control, activate or deactivate automatic lane centering system 16. When automatic lane centering control 16 is activated it may control the steering of the vehicle, and when deactivated, the steering of the vehicle may be controlled by the driver, manually steering the vehicle, using steering wheel 11 or other controls. User control 14a may also enable a driver to select a smoothness to be converted to a smoothness factor to be applied by automatic lane centering system 16 in controlling vehicle 10.

Driver interface device 14 may include an output device 14b. Output device 14b may include, for example, a display screen, and indicator light or panel, a dial, or an audio output device such as a speaker. For example, automatic lane centering system 16 may communicate to the driver a current status or a warning via output device 14b.

Input 19 may include camera 12. Camera 12 may include one or more imaging devices that provide image-based information to automatic lane centering system 16. Typically, camera 12 includes at least one forward-looking (in the usual direction of travel) camera. The forward-looking camera may have sufficient field of view and resolution, and may be suitably aimed, so as to enable detection of lane markings 24 that indicate the sides of lane 20, or the edges of a road or path. For example, a forward-looking camera may be mounted behind a rearview mirror, or any other location within or on vehicle 10. The location may be selected so as not to obstruct the drivers view of the road ahead of vehicle 10.

Camera 12 may be capable of acquiring images or video frames at a sufficient rate so as to enable operation of automatic lane centering system 16. Automatic lane centering system 16 includes image processing capabilities for interpreting an image acquired by camera 12. Processing one or more images acquired by camera 12 may provide information regarding a position of vehicle 12 with respect to center line 22. Processing may also yield a calculated shape of lane 20 and of center line 22 in a region ahead of vehicle 10. For example, processing may result in a lane marking 24 or center line 22 being represented by one or more of a second order or higher order polynomial equation, a lane position with respected to a center of vehicle 12, a heading angle, curvature, or rate of curvature change.

Camera 12 may include two or more imaging devices that operate in different spectral ranges. For example, operation in two or more spectral ranges may be used to enhance the detectability of a lane marking 24, or to expand the range of range of conditions (e.g. weather related or illumination conditions) under which lane marking 24 may be detected. Two or more cameras aimed in different directions, or viewing a single scene from different angles (e.g. forming a binocular pair), may further enhance the capabilities of automatic lane centering system 16. For example, one or more rear-facing cameras can be used (e.g. in combination with a map or GPS) to enhance the forward-looking camera's lane sensing capability.

Alternatively or in addition to camera 12, input 19 may include data from any other sensor capable of detecting a lane, road marking or an edge. For example, lane may be delineated using electromagnetic markings detectable using an appropriate electromagnetic detector. Lane detection may be enhanced by information from a GPS device with reference to a map database.

Input 19 may include radar device 13. Radar device 13 may include one or more radar devices of various ranges. Radar device 13 may enable detection of, and determination of the relative position and motion of, an object 26. Object 26 may include, for example, another vehicle, an obstacle or fixed object in, or adjacent to lane 20, or a pedestrian. Automatic lane centering system 16 may adjust its control of vehicle 10 so as to avoid a collision or close encounter with object 26. Alternatively or in addition to radar device 13, input 19 may include input from any device capable of detecting objects. Such devices may include, for example, a laser rangefinder, LIDAR, or a sonic rangefinder.

Input 19 may include input from vehicle sensor 15. Vehicle sensor 15 may include one or more sensors that acquire information from systems of vehicle 10. Such information may indicate a current state of operation of vehicle 10, or may provide information regarding the motion of vehicle 10. For example, sensor 15 may include input from an onboard or portable GPS system, speedometer, accelerometer, gyroscope, compass, steering sensor, or tachometer.

Input 19 may be processed by processor 9 associated with automatic lane centering system 16 to provide information regarding measured or derived quantities that represent the motion of vehicle 10. Such quantities may include for example, speed, acceleration, heading angle, yaw rate, lateral speed (e.g. all derived from a steering sensor or other sensor of vehicle sensor 15), and a lateral position in lane 20 (e.g. derived from a forward-looking camera of camera 12), of vehicle 10.

As a result of analysis of input 10, automatic lane centering system 16 may calculate a path of vehicle 10 for a predetermined period of time. Automatic lane centering system 16 may control steering of vehicle 10 via a steering actuator 18. Steering actuator 18 may include, for example, an electrical power steering (EPS) system or an active front steering (AFS) system that is alternatively operable by a driver using steering wheel 11. Steering actuator 18 may include one or more motors or servo motors which may rotate road wheels (e.g. tire 8) or other parts of the steering system in accordance with the calculated path. In addition, a path may need to be calculated to transition the vehicle from a non-centered (e.g., operated by a driver) path to a centered (e.g., autonomously operated by a lane centering system) path. This transition path from a driver-operated mode to an automatic lane centered mode may be sharp and aggressive, smooth and gradual, or in-between. The calculated transition path may be calculated using a function of smoothness, or a smoothness value, that is input to automatic lane centering system 16 via driver interface 14.

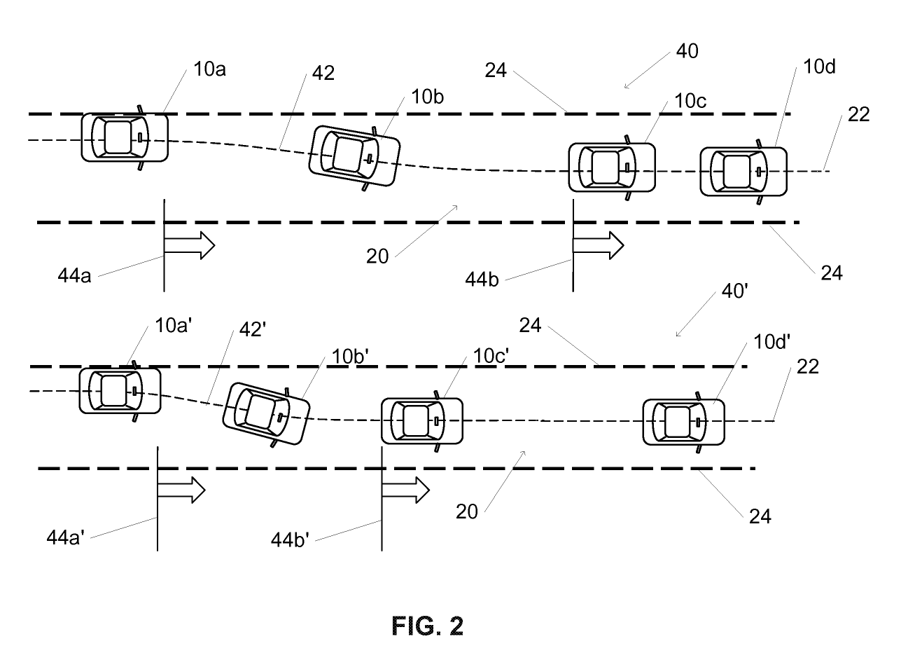

FIG. 2 illustrates schematically an example of an effect of different smoothness levels on a calculated vehicle path for transition to automatic lane centering, in accordance with an embodiment of the present invention. With respect to FIG. 2 and with respect to other figures referenced below, the discussion contrasts two different lane centering transition smoothness levels, one labeled “conservative”, and the other labeled “non-conservative” (or “aggressive”). It should be understood, however, that a continuum of smoothness levels are possible. The smoothness levels may be labeled differently, and as described below, each may be associated with a numerical value.

Conservative lane centering transition 40 and non-conservative lane centering transition 40′ illustrate a driver having selected a smooth path and a less smooth path, respectively. Vehicles 10a-10d represent positions of a single vehicle at successive times during conservative lane centering transition 40. Similarly, vehicles 10a′-10d′ represent positions of a single vehicle at successive times during non-conservative lane centering transition 40′. In both cases, the vehicle is maneuvered from traveling near lane marking 24 (vehicles 10a and 10a′), for example when the vehicle is not under the operation of a lane centering system, to traveling along center line 22, when the vehicle is under the operation of a lane centering system. As discussed a lane centering system may maneuver a vehicle in a path not at the center of a lane.

In conservative transition to lane centering 40, the maneuver follows maneuver path 42. Maneuver path 42 begins at starting position 44a and ends at ending position 44b. Similarly, in non-conservative transition to lane centering 40′, the maneuver follows maneuver path 42′. Maneuver path 42′ begins at starting position 44a′ and ends at ending position 44b′.

Comparing conservative transition to lane centering 40 with non-conservative transition to lane centering 40′, it may be noted that the distance between starting position (e.g., when a command or request to begin lane centering control occurs) 44a and ending position 44b is greater than the distance between starting position 44a′ and ending position 44b′. Similarly, comparing vehicles 10b and 10b′ (while the vehicle is following transition maneuver path 42 and transition maneuver path 42′, respectively), vehicle 10b′ is turned at a steeper angle with respect to center line 22 than vehicle 10b.

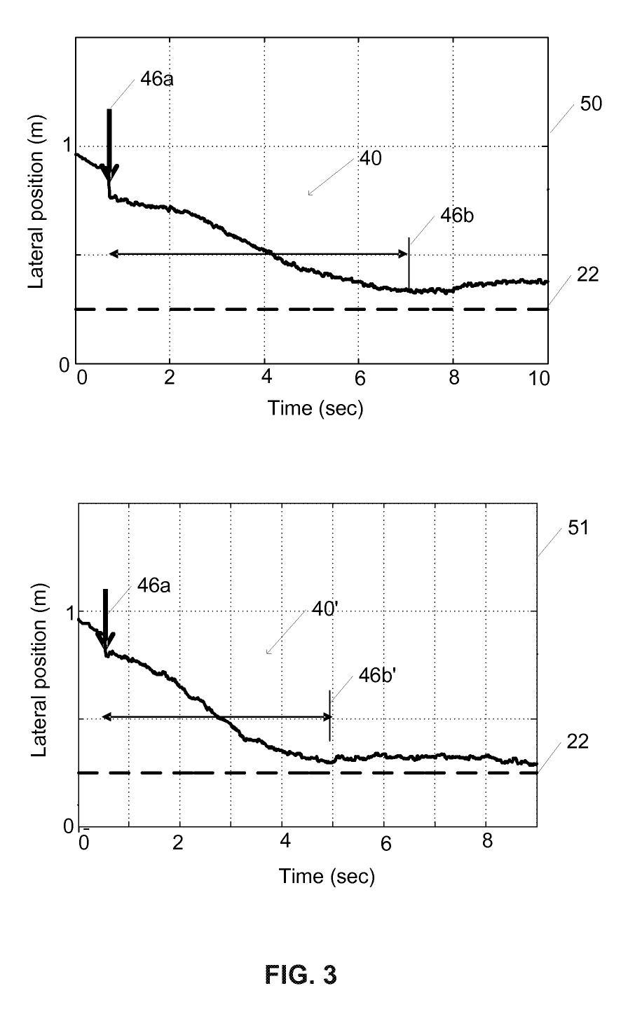

FIG. 3 illustrates graphically an example of an effect of different smoothness levels on transition to automatic lane centering, in accordance with an embodiment of the present invention. Graph 50 represents a plot of lateral position versus time for a vehicle undergoing transition to conservative lane centering 40. Similarly, graph 51 represents a plot of lateral position versus time for a vehicle undergoing transition to non-conservative lane centering 40′. The lateral position of the vehicle is measured in meters from a reference point on the vehicle (e.g. a side of the vehicle, a center line of the vehicle, or a position of a camera or other sensor in the vehicle) to the middle of a lane in which a vehicle is to travel. Center line 22 represents a desired final lateral position of the vehicle. In the case illustrated in graphs 50 and 51, center line 22 is displaced by 0.25 m from the actual middle of the lane. Such a displacement may be selected by a driver, for example, when the driver wishes to avoid approaching a side of the lane too closely (e.g. to the presence of a guard rail, vegetation or other obstacles, or a bicycle or pedestrian path on that side of the lane). Alternatively, an automatic lane centering system may automatically select a displacement under predetermined circumstances.

The origin of the time axis of graphs 50 and 51 begins in one example about 0.5 seconds prior to initiation of automatic lane centering at starting time 46a. Lane centering is initiated at starting time 46a. For example, a driver may have operated a control for initiating automatic lane centering. Alternatively, a navigation system of the vehicle may have noticed that the vehicle has drifted laterally away from center line and may send a warning to the driver and suggest automatic line centering. The driver may then ignore the warning, operate a control to cancel the warning, or may operate a control to initiate automatic lane centering. Only in the latter case, then, is automatic lane changing initiated. In other embodiments, other ways of initiating lane centering may be used.

After starting time 46a, both in the case of conservative lane transition to centering 40 and in the case of non-conservative transition to lane centering 40′, the lateral position of the vehicle approaches the lateral position of center line 22. At ending time 46b for the transition via conservative lane centering transition 40, and at ending time 46b′ for the transition via non-conservative lane centering transition 40′, the lateral position of the vehicle has reached center line 22 as defined by a parameter of the automatic lane centering system, and the vehicle is guided along a lane centered path. For example, an automatic lane centering system may refer to a threshold distance for determining when the vehicle has reached center line 22. The automatic lane centering system may determine that the vehicle has reached center line 22 when the lateral distance of the vehicle from center line 22 is less than the threshold distance.

In the example, of FIG. 3, the lateral distance traveled by the vehicle is about a half of a meter. In the case of conservative lane centering 40, that lateral distance is traveled in about 7 seconds. In the case of non-conservative lane centering 40′, the lateral distance is traveled in about 4.5 seconds. This difference between conservative lane centering 40 and non-conservative lane centering 40′ may be perceptible to a driver of the vehicle. Other times may be used.

Different drivers may have different driving styles, or may have different personality traits that lead to different preferences with regard to lane centering. For example, some drivers may prefer a relatively quick maneuver. Such drivers may, e.g. feel impatient when the time to move to full lane centering requires a (subjectively) excessive amount of time, or may feel that no maneuver is taking place. On the other hand, other drivers may prefer a smoother ride, and may prefer that the transition to automatic lane centering be performed slowly. For example, such drivers may be startled by, or may be made physically uncomfortable by, relatively sudden movements of the vehicle.

A smoothness level for transition to automatic lane centering may be selected by a driver of a vehicle using an appropriate control. For example, the control may be selected using an appropriate control from two or more options along a scale (e.g. one end of the scale being labeled “more smooth”, and the other being labeled “less smooth”).

A value of a smoothness parameter (as described below) may depend on both the driver's selection, and on known characteristics of the vehicle being driven. For example, a taller vehicle (e.g. truck, van, or bus) may be provided with a range of smoothness parameters that enable smoother transition to lane centering than would be a shorter vehicle (e.g. car). A smoothness parameter may also be affected by handling characteristics of a vehicle or a typical driver or passenger. For example, a luxury car or family car may be provided with a range of smoothness parameters that enable smoother lane centering than would be a sports car. Other characteristics may be related to weight and handling characteristics of the vehicle. Thus, for example, automatic lane centering in two different vehicles whose drivers selected similar smoothness levels may in fact be automatically operated with different degrees of smoothness as determined by the smoothness parameter. A vehicle recording system may record driving habits of a driver, and adjust a smoothness parameter accordingly.

As another example, an automatic lane centering system may receive input from one or more sensors or receivers that is indicative of weather conditions. In this case, a smoothness parameter may also be affected by weather conditions (e.g. meteorological conditions that indicate a likely dryness or wetness of a roadway, or a likely presence or absence of ice).

Calculation of a path for transition to automatic lane centering, in accordance with embodiments of the present invention, may depend on an entered, calculated or derived smoothness level, and a corresponding smoothness parameter, in accordance with a path calculation method.

In accordance with an embodiment of the present invention, a smoothness time parameter determines or is converted to the amount of time that is allowed for the vehicle to transition to lane centering, for example by performing an automatic lane centering maneuver. A path for automatic lane centering may then be calculated in accordance with the smoothness time parameter. The maneuver may be controlled by for example automatic lane centering system 16.

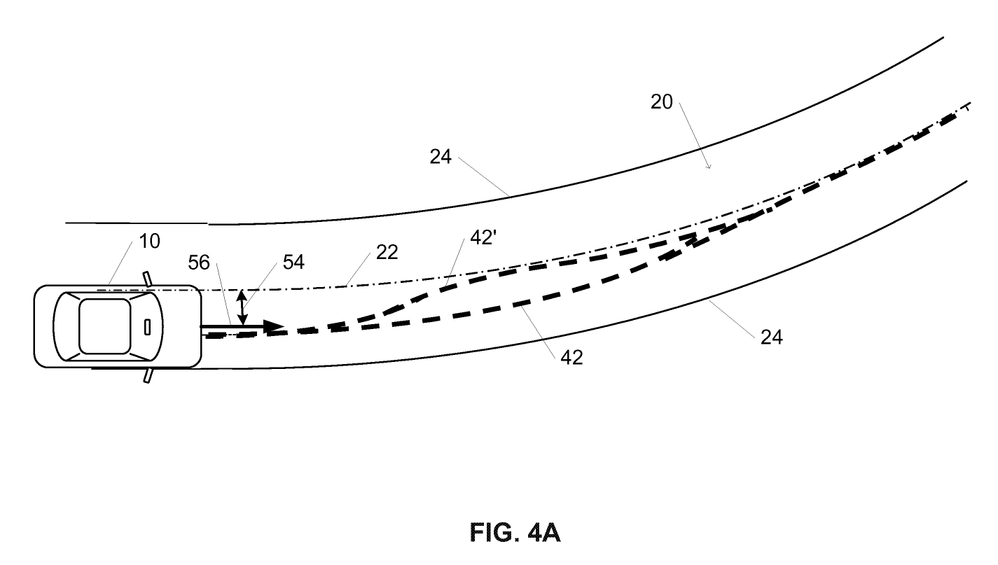

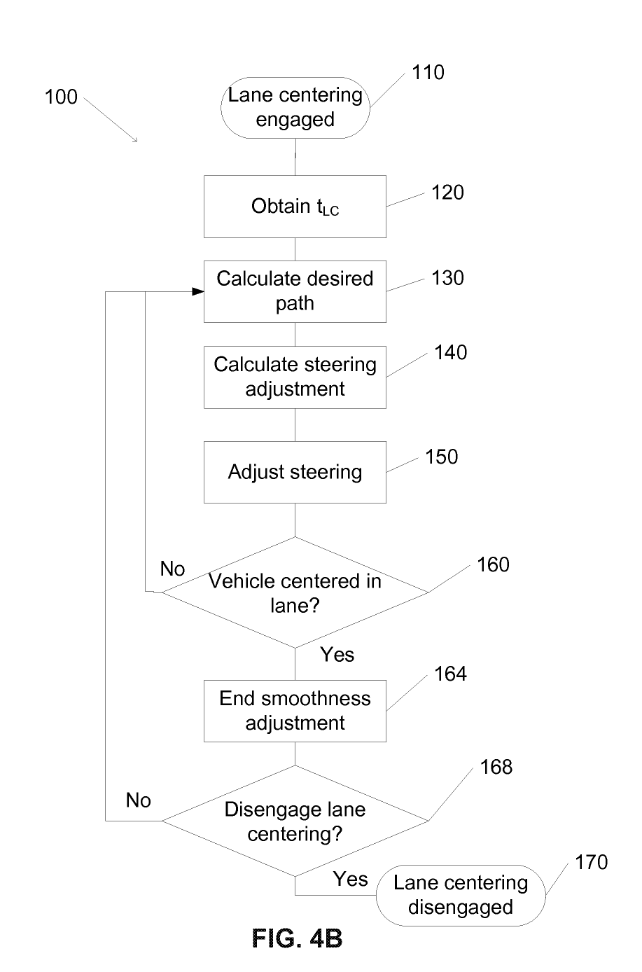

FIG. 4A illustrates the result of adjustment of smoothness of transition to lane centering by determining a time period for completing the transition to lane centering in a vehicle traveling on a roadway, in accordance with an embodiment of the present invention. In accordance with this embodiment, a driver's selection of a smoothness results in determining an amount of time required to perform transition to lane centering. Increasing the amount of time required for a lane centering maneuver results in a smoother lane centering operation. Conversely, reducing the amount of time results in a less smooth lane centering operation.

At each position of vehicle 10 on lane 20, a desired path of vehicle 10 may be expressed as a collection of values that are parameterized by a time parameter t. These values include a lateral distance 54 between a reference point of vehicle 10 and center line 22 (a desired line of travel, which may be off center relative to the lane or road), lateral distance 54 being represented by yᵣ. An instantaneous velocity of vehicle 10, indicated by velocity vector 56, may be represented by a velocity v (decomposable into a longitudinal vₓ component and a transverse v_{y} component) and heading φ. Each point on the path may also be characterized by a curvature ρ.

A time to complete lane centering, the smoothness parameter in this embodiment, may be represented by t_{LC}. The parameter t_{LC} may be based on data that is directly input by a driver, or may be derived or converted (e.g., using a table or formula) by an automatic lane centering system from a smoothness level that is input by the driver. Typically, t_{LC}, is based on lateral distance 54 (with t_{LC} increasing when lateral distance 54 increases). A larger value of t_{LC} (longer lane centering time) results in a smoother (more conservative) lane centering maneuver path 42 that with a smaller value of t_{LC}, resulting a less smooth (non-conservative) lane centering maneuver path 42′.

A desired lane centering transition maneuver path 42 or 42′ may then be expressed as a normalized fifth degree polynomial with coefficients a₀-a₅:

yₙ(x)=a₀+a₁xₙ+a₂xₙ³+a₄xₙ⁴+a₅xₙ⁵.

The normalized distances xₙ and yₙ may be expressible as

$${x}_{n} ( t ) = \frac{x ( t )}{x ( {t}_{LC} )} and {y}_{n} ( x ( t ) ) = \frac{y ( x ( t ) )}{y ( x ( {t}_{LC} ) )} ,$$

and where x(t)=vₓ·t,

with x representing a longitudinal distance measured forward from the center of the vehicle, y representing a lateral distance measured (in this case leftward) from the center of the vehicle, and t representing a time measured from the present.

The path may be calculated in accordance with continuity conditions. A first continuity condition requires that maneuver path 42 or 42′ begins in accordance with a current position relative position (xₙ=yₙ=0) and motion (zero relative direction angle) of vehicle 10, and may be expressed as

$${( {y}_{n} ( {x}_{n} ) , {{y}^{′} ( {x}_{n} )}_{n} , {{y}^{″} ( {x}_{n} )}_{n} )}_{t = 0} = ( 0 , 0 , ρ \cdot \frac{{x}^{2} ( {t}_{LC} )}{y ( {t}_{LC} )} ) ,$$

where y′ represents a first derivative with respect to xₙ (dyₙ/dxₙ) and y″ represents a second derivative with respect to xₙ (d²y/dxₙ²).

A second continuity condition requires that the end of maneuver path 42 or 42′, at time t_{LC}, coincides with center line 22. The second continuity condition may be expressed as

$${( {y}_{n} ( {x}_{n} ) , {y}_{n}^{′} ( {x}_{n} ) , {y}_{n}^{″} ( {x}_{n} ) )}_{t = {t}_{LC}} = ( 1 , ( ρ + tan ( {ϕ}_{1} ) ) \cdot \frac{x ( {t}_{LC} )}{y ( {t}_{LC} )} , ρ \cdot \frac{{x}^{2} ( {t}_{LC} )}{y ( {t}_{LC} )} ) .$$

where φ₁ represents a relative direction of the end of maneuver path 42 or 42′ relative to the initial (current) heading of vehicle 10.

The equations may be solved to determine parameters a₀-a₅. For example, a linear method of solving the equations is described by Lee in US Published application 2009/0319113, incorporated by reference herein in its entirety. Other sets of equations for calculating a path or maneuver may be used.

Once a maneuver path 42 or 42′ has been calculated, steering of vehicle 10 may be adjusted. For example, an angular difference between a current heading of vehicle 10 and a heading in accordance with maneuver path 42 or 42′ may be calculated. Steering of vehicle 10 may then be adjusted in accordance with the calculated angular difference. For example, such steering adjustment is described by Lee in US published application 2010/0228420, incorporated herein by reference in its entirety. For example, a motor or servo (e.g., servo 18 shown in FIG. 1) may adjust a steering wheel (e.g., steering wheel 11 shown in FIG. 1) or a steering system directly to adjust the steering of the vehicle.

FIG. 4B is a flowchart of a method for adjustment of smoothness of lane centering by determining a time period for completing a transition to lane centering, in accordance with an embodiment of the present invention. Automatic lane centering method 100 may be implemented by an automatic lane centering system of a vehicle that is traveling along a roadway for example with a marked lane.

An automatic lane centering system or capability of the vehicle may be engaged by, or may have previously been engaged by, a driver of the vehicle (step 110). For example, the automatic lane centering system may be engaged by a driver of a vehicle, or by an automatic device (e.g., automatic steering control) that is associated with the vehicle. Engaging the automatic lane centering system may be subject to a current availability. For example, availability may be limited in accordance with detected traffic or road conditions.

Once engaged, the lane centering system may initiate control of the steering of the vehicle to maintain or maneuver the vehicle to cause the vehicle to travel along a predetermined center line, for example of a marked lane.

A value of the lane centering time t_{LC} is obtained or accepted (step 120). For example, a preliminary value of a lane centering time may be based on a lateral distance of the vehicle from the center line (with the preliminary value increasing as a function of the lateral distance). The preliminary value may be adjusted in accordance with a desired smoothness so as to obtain t_{LC}. For example, a smoothness level (e.g., derived from a driver-selected smoothness rating, or at least partially based on a pre-calculated or fixed value for a particular vehicle or type of vehicle) may be converted to a multiplier that may be multiplied with the preliminary value to obtain t_{LC}. Time t_{LC} may represent a time required to complete a lane centering maneuver. The lane centering maneuver when discussed herein may be the time taken to transition from a path not controlled by lane centering to a path along a center line, controlled by lane centering.

A desired lane centering path (e.g., a path for transition from non-lane centering to a path along a center line) may then be calculated based on sensor input and on the obtained value of t_{LC} (step 130). For example, the path may be calculated on the basis of a function (e.g. a polynomial function) that smoothly connects a sensed current heading of the vehicle with a sensed center line as determined by lane markings. A lane centering transition path for the transition maneuver may be based on a current heading of the vehicle relative to a sensed center line and on the time to complete.

A steering adjustment may be calculated based on the calculated path (step 140). For example, the steering adjustment may be calculated based on an angular difference between a current heading of the vehicle and on a desired heading of the vehicle based on the calculated path. The steering adjustment may then be calculated as an angle by which the rotatable wheels of the vehicle should be turned in order to achieve an appropriate adjustment in vehicle heading. Alternatively, a steering adjustment may be calculated as a torque that is to be applied to the rotatable wheels of the vehicle.

The automatic lane centering system may then control the steering of the vehicle to adjust the steering in accordance with the calculated steering adjustment (step 150). For example, an appropriate command may be transmitted to an electrical power or other steering system of the vehicle. A motor or servo (e.g., servo 18 shown in FIG. 1) may adjust a road wheel (e.g., tire 8 shown in FIG. 1) or a steering system directly to adjust the steering of the vehicle.

Sensor input may indicate whether or not the vehicle is traveling along the center line of the lane after the steering adjustment (step 160). If the vehicle is currently traveling along the center line (e.g. the length of the calculated path is less than a threshold value), the current automatic transition to lane centering with the smoothness adjustment is terminated (step 164). If not, a further path and steering adjustment may be calculated and implemented based on the current heading of the vehicle (returning to step 130).

Alternatively, the path need not be recalculated (e.g. the curvature of the center line is constant and no new obstacles have appeared). In this case, if the vehicle has not reached the end of the calculated path, a steering adjustment may be calculated and implemented such that the vehicle continues to travel along the calculated path (returning to step 140).

At any point, a driver of the vehicle or a processor associated with the automatic lane centering system may decide whether or not to disengage the automatic lane centering system (step 168). As a result of a decision to disengage, the automatic lane centering system is disengaged (step 170). For example, the driver may wish to manually steer the vehicle or the automatic lane centering system may detect conditions that require driver control of the vehicle. If the automatic lane centering system is not disengaged, a path and steering adjustments may continue to be calculated and implemented based on the current heading of the vehicle in order to maintain travel along the center line (returning to step 130).

Other operations or series of operations may be used.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

A processor-readable non-transitory storage medium may include, for example, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein.

Features of various embodiments discussed herein may be used with other embodiments discussed herein. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method comprising:
accepting a time to complete a transition to lane centering maneuver for a vehicle traveling on a roadway;
calculating a lane centering path for the maneuver, based on a sensed current heading of the vehicle relative to a sensed center line as determined by the time to complete;
calculating a steering adjustment required for the vehicle to execute the maneuver with respect to the calculated lane centering path; and
applying the steering adjustment to the vehicle.

2. The method of claim 1, wherein the steering adjustment comprises an angular adjustment of a rotatable steering wheel of the vehicle.

3. The method of claim 1, comprising determining the time to complete based on a smoothness level for the lane centering maneuver.

4. The method of claim 1, wherein calculating a lane centering path comprises determining coefficients of a normalized fifth degree polynomial equation.

5. The method of claim 1, wherein calculating the lane centering path comprises calculating a path that smoothly connects the sensed current heading with the sensed center line.

6. The method of claim 1, wherein calculating the steering adjustment comprises calculating an angle between the sensed current heading and the calculated lane centering path.

7. A computer readable non-transitory storage medium, including instructions, which when executed by a processor cause the processor to carry out the method of:
obtaining a time to complete a transition to lane centering maneuver for a vehicle traveling on a roadway;
calculating a lane centering path for the maneuver, based on a sensed current heading of the vehicle relative to a sensed center line as determined by the time to complete;
calculating a steering adjustment required for the vehicle to execute the maneuver with respect to the calculated lane centering path; and
applying the steering adjustment to the vehicle.

8. The computer readable non-transitory storage medium of claim 7, wherein the steering adjustment comprises an angular adjustment of a rotatable steering wheel of the vehicle.

9. The computer readable non-transitory storage medium of claim 7, wherein the instructions, when executed by a processor cause the processor to further carry out the method of determining the time to complete based on a smoothness level for the lane centering maneuver.

10. The computer readable non-transitory storage medium of claim 7, wherein calculating a lane centering path comprises determining coefficients of a normalized fifth degree polynomial equation.

11. The computer readable non-transitory storage medium of claim 7, wherein calculating the lane centering path comprises calculating a path that smoothly connects the sensed current heading with the sensed center line.

12. The computer readable non-transitory storage medium of claim 7, wherein calculating the steering adjustment comprises calculating an angle between the sensed current heading and the calculated lane centering path.

13. A system comprising:
a memory; and
a processor configured to:
obtain a time to complete a transition to lane centering maneuver for a vehicle traveling on a roadway;
calculate a lane centering path for the maneuver, based on a sensed current heading of the vehicle relative to a sensed center line as determined by the time to complete;
calculate a steering adjustment required for the vehicle to execute the maneuver with respect to the calculated lane centering path; and
apply the steering adjustment to the vehicle.

14. The system of claim 13, wherein the steering adjustment comprises an angular adjustment of a rotatable steering wheel of the vehicle.

15. The system of claim 13, wherein the processor is further configured to determine the time to complete based on a smoothness level for the lane centering maneuver.

16. The system of claim 13, wherein to calculate a lane centering path the processor is configured to determine coefficients of a normalized fifth degree polynomial equation.

17. The system of claim 13, wherein to calculate the lane centering path the processor is configured to calculate a path that smoothly connects the sensed current heading with the sensed center line.

18. The system of claim 13, wherein to calculate the steering adjustment the processor is configured to calculate an angle between the sensed current heading and the calculated lane centering path.

19. The system of claim 13, further comprising at least one sensor for sensing the current heading of the vehicle and the center line.

20. The system of claim 13, further comprising a steering operator for applying the steering adjustment to the vehicle.
